(19) United States
(12) Patent Application Publication
(10) Pub. No.: US 2012/0313838 A1
(43) Pub. Date: Dec. 13, 2012

(54) INFORMATION PROCESSOR, INFORMATION PROCESSING METHOD, AND COMPUTER PROGRAM PRODUCT

(76) Inventor: Susumu Kasuga, Tokyo (JP)

(21) Appl. No.: 13/413,423

(22) Filed: Mar. 6, 2012

(30) Foreign Application Priority Data
Jun. 7, 2011 (JP) 2011-127339

(51) Int. Cl. G09G 5/00

(52) U.S. Cl. 345/1.3

(57) ABSTRACT

According to one embodiment, an information processor includes a display controller and a detector. The display controller virtually arranges screens of a plurality of display devices to form a continuous screen for display. The detector detects whether an operation object moves to a periphery of a main screen of the screens a predetermined number of times. The display controller sets the display position of one of the screens other than the main screen to a position corresponding to the periphery where the movement of the operation object is detected by the detector.

### CROSS-REFERENCE TO RELATED APPLICATIONS

This application is based upon and claims the benefit of priority from Japanese Patent Application No. 2011-127339, filed Jun. 7, 2011, the entire contents of which are incorporated herein by reference.

### FIELD

Embodiments described herein relate generally to an information processor, an information processing method, and a computer program product.

### BACKGROUND

Multi-display (multi-monitor) is known as technology for increasing the display area of a single information processor such as a personal computer (PC) using a plurality of display devices connected to the information processor. In the conventional technology, screen display settings that specify how a plurality of screens are arranged are configured by setting screen properties with the operating system (OS).

In the conventional technology, the position change of a display requires screen properties to be displayed and specified again, which is troublesome. Especially, when mobile PCs such as notebook PCs and slate PCs are used in a multi-display configuration, the actual position of the display can be easily changed. Thus, there is a need for a technology that facilitates screen display settings.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an information processor according to a first embodiment;

FIG. 2 is an exemplary block diagram of a hardware configuration of the information processor in the first embodiment;

FIG. 3 is an exemplary functional block diagram of the information processor in the first embodiment;

FIGS. 4 to 7 are exemplary schematic diagrams for explaining a trigger motion in the first embodiment;

FIG. 8 is an exemplary flowchart of a display setting change process performed by the information processor in the first embodiment;

FIG. 9 is an exemplary schematic diagram for explaining a trigger motion in the case where a window is dragged in the first embodiment; and

FIG. 10 is an exemplary schematic diagram for explaining display setting change operation according to a second embodiment.

### DETAILED DESCRIPTION

In general, according to one embodiment, an information processor comprises a display controller and a detector. The display controller is configured to virtually arrange screens of a plurality of display devices to form a continuous screen for display. The detector is configured to detect whether an operation object moves to a periphery of a main screen of the screens a predetermined number of times. The display controller is configured to set the display position of one of the screens other than the main screen to a position corresponding to the periphery where the movement of the operation object is detected by the detector.

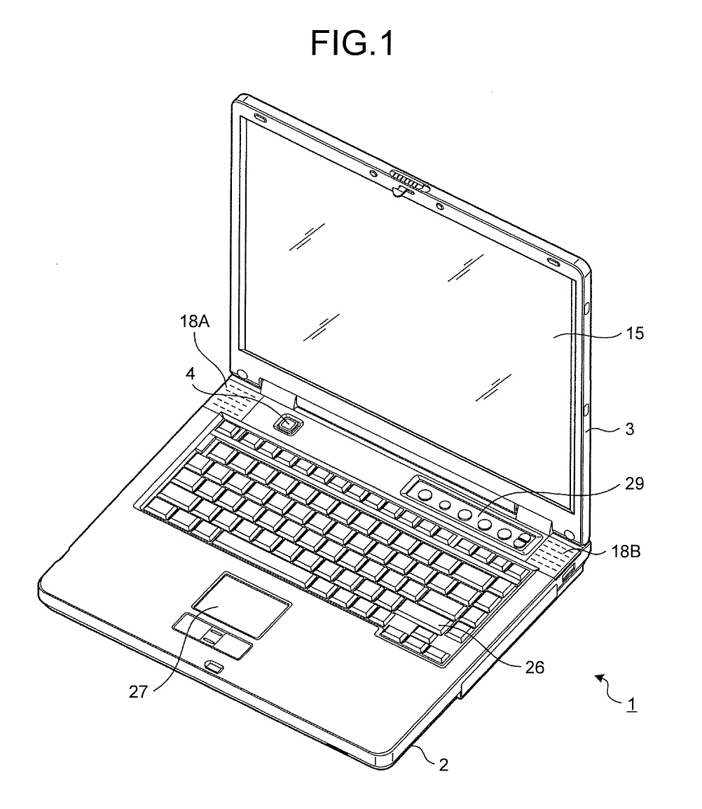

FIG. 1 is a perspective view of an information processor 1 according to a first embodiment. Although the information processor 1 will be described by way of example as a notebook personal computer (PC) in the first embodiment, it is not so limited. The information processor 1 may be, for example, a desktop PC, a tablet PC, a slate PC, personal digital assistant (PDA), a smartphone, or the like. Like reference numerals refer to corresponding parts throughout the several views of the drawings, and the same description is not repeated.

As illustrated in FIG. 1, the information processor 1 comprises a main body 2 and a display module 3. The display module 3 is movable between open and closed positions with respect to the main body 2 . The display module 3 comprises a built-in display 15. The main body 2 is provided with, on its upper surface, a keyboard 26, a power button 4, an operation panel 29, a touchpad 27, speakers 18A and 18B, and the like. The operation panel 29 comprises various operation buttons.

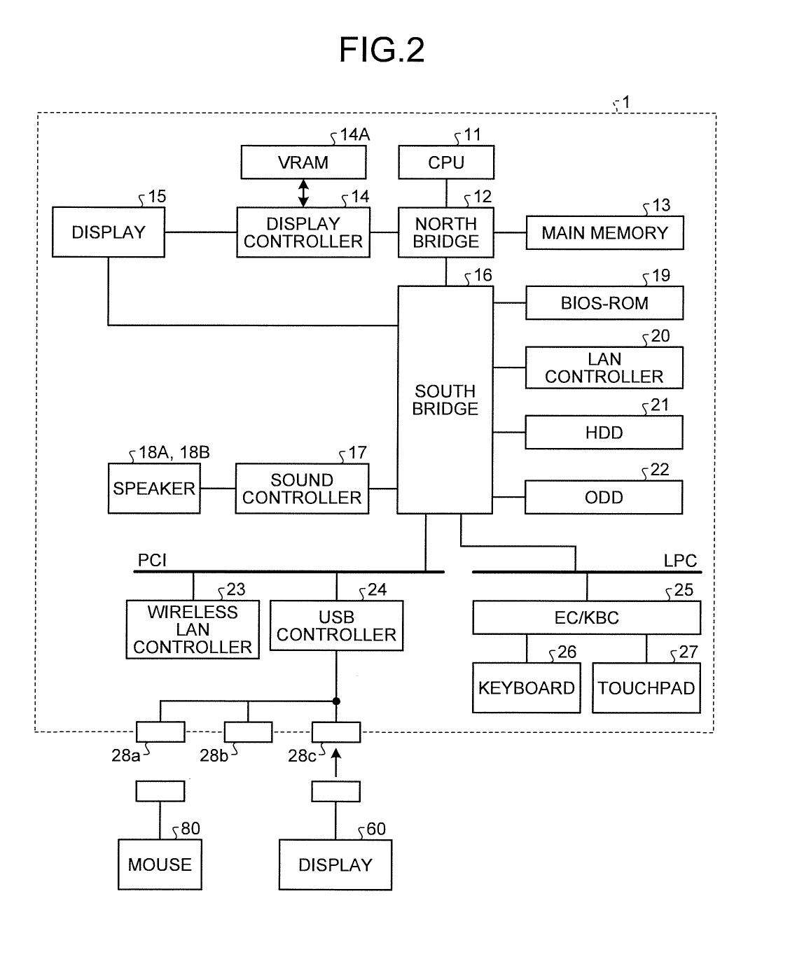

A description will be given of a hardware configuration provided in the main body 2 . FIG. 2 is a block diagram of a hardware configuration of the information processor 1.

As illustrated in FIG. 2, the information processor 1 comprises a central processing unit (CPU) 11, a north bridge 12, a main memory 13, a display controller 14, a video random access memory (VRAM) 14A, the display 15, a south bridge 16, a sound controller 17, the speakers 18A and 18B, a BIOS-ROM 19, a local area network (LAN) controller 20, a hard disk drive (HDD) 21, an optical disc drive (ODD) 22, a wireless LAN controller 23, a universal serial bus (USB) controller 24, an embedded controller/keyboard controller (EC/KBC) 25, the keyboard 26, the touchpad 27, and the like.

The north bridge 12 connects between a local bus of the CPU 11 and the south bridge 16. The north bridge 12 comprises a built-in memory controller that controls access to the main memory 13. The north bridge 12 has the function of communicating with the display controller 14.

The display controller 14 controls the display 15 used as a main display of the information processor 1. The display 15 receives a display signal generated by the display controller 14 and displays an image based on the display signal. Examples of the image displayed by the display 15 include moving images and still images.

The south bridge 16 controls each device on a peripheral component interconnect (PCI) bus as well as a low pin count (LPC) bus. The south bridge 16 comprises a built-in integrated drive electronics (IDE) controller that controls the HDD 21 and the ODD 22. The south bridge 16 further comprises a built-in memory controller that controls access to the BIOS-ROM 19. Besides, the south bridge 16 has the function of communicating with the sound controller 17 and the LAN controller 20.

The sound controller 17 is an audio source device, and outputs audio data to be reproduced to the speakers 18A and 18B. The LAN controller 20 is a wired communication device that performs wired communication based on, for example, the Ethernet (registered trademark) standard. On the other hand, the wireless LAN controller 23 is a wireless communication device that performs wireless communication based on, for example, the IEEE802.11 standard. The USB controller 24 communicates with an external device via, for example, a USB 2.0 cable.

The EC/KBC 25 is a one-chip microcomputer comprising the integration of an embedded controller (EC) for power management and a keyboard controller (KBC) for controlling the keyboard 26 and the touchpad 27. The EC/KBC 25 has the function of turning on/off the information processor 1 in response to user's operation.

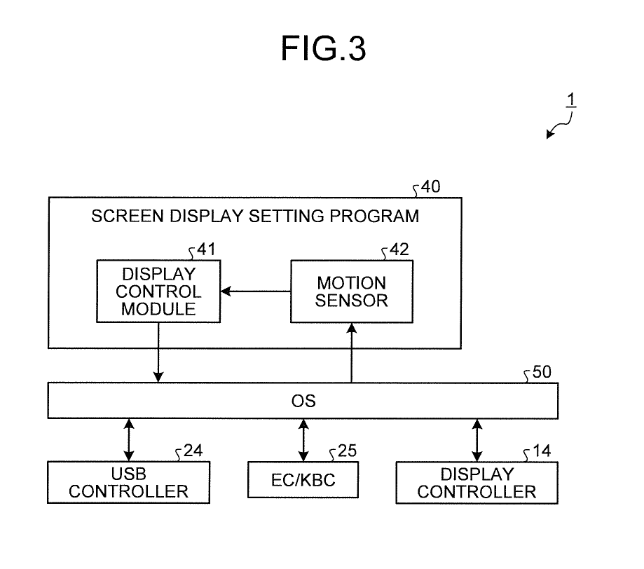

The BIOS-ROM 19 stores a system basic input-output system (BIOS). The HDD 21 stores an operating system (OS) 50 and a screen display setting program 40 (see FIG. 3).

The CPU 11 is a processor that controls the operation of the information processor 1. The CPU 11 loads the BIOS from the BIOS-ROM 19 into the main memory 13 and executes it. The CPU 11 also loads various types of programs including the screen display setting program 40 and the OS 50 from the HDD 21 into the main memory 13 and executes them (see FIG. 3).

The USB controller 24 is provided with a plurality of USB connectors 28a, 28b, and 28c. Various types of USB devices, such as a display 60 used as a sub-display and a mouse 80, can be connected to the USB controller 24 via the USB connectors 28a, 28b, and 28c.

The display 60 is used as a sub-display in the information processor 1. The display 60 need not necessarily be connected to the information processor 1 by USB connection. The display 60 may be connected to the information processor 1 via a high-definition multimedia interface (HDMI), a digital visual interface (DVI), various types of wireless connection, and the like. A plurality of sub-displays may be connected to the information processor 1.

A functional configuration of the information processor 1 will be described. FIG. 3 is a functional block diagram of the information processor 1.

The OS 50 is software that provides basic functions used in common by various application software programs and manages the entire computer system of the information processor 1, such as disk and memory management. The OS 50 manages input from the keyboard 26 and the touchpad 27 through the EC/KBC 25. The OS 50 also manages input/output from/to USB devices such as the display 60 and the mouse 80 through the USB controller 24. Further, the OS 50 manages output to the display 15 through the display controller 14.

The screen display setting program 40 is a program to specify settings for screen display on the display 15, the display 60, and the like together with the OS 50 based on operation through a pointing device such as the mouse 80 or the touchpad 27.

The screen display setting program 40 executed on the information processor 1 is provided as being stored in a computer-readable storage medium, such as a compact disk read-only memory (CD-ROM), a flexible disk (FD), a compact disc-recordable (CD-R), or a digital versatile disc (DVD), in an installable or executable format.

The screen display setting program 40 executed on the information processor 1 may also be stored in a computer connected via a network such as the Internet so that it can be downloaded therefrom via the network. Further, the screen display setting program 40 may be provided or distributed via a network such as the Internet. The screen display setting program 40 may also be provided as being stored in advance in ROM or the like.

As illustrated in FIG. 3, the screen display setting program 40 comprises modules including a display control module 41 and a motion sensor 42. When the CPU 11 (processor) loads the screen display setting program 40 from the HDD 21 into the main memory 13 and executes it, the display control module 41 and the motion sensor 42 are implemented on the main memory 13.

As illustrated in FIG. 3, the display control module 41 controls display on the display 15 connected to the display controller 14 and the display 60 connected to the USB controller 24 via the OS 50. The display control module 41 supports the multi-display function and is capable of using the screens of the displays 15 and 60 as a seamless or continuous wide screen (hereinafter, “virtual display”).

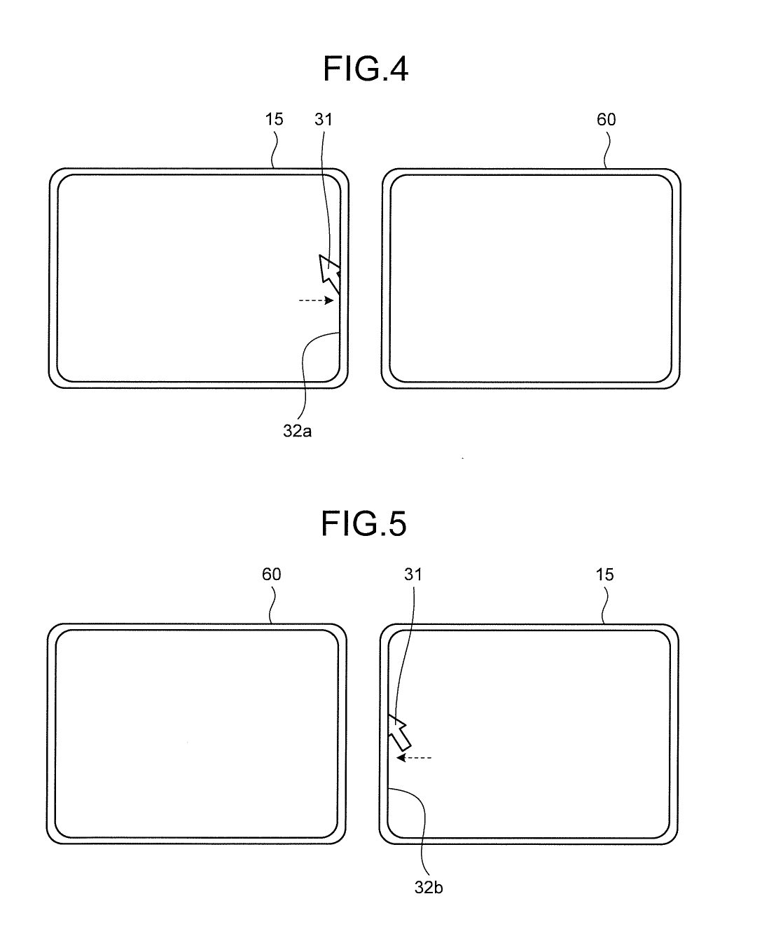

The motion sensor 42 detects a trigger motion to change screen display settings based on the motion of an operation object on the display 15 as a main display. For example, the motion sensor 42 detects a trigger motion based on the movement of a pointer 31 (see FIGS. 4 to 7).

FIGS. 4 to 7 are schematic diagrams for explaining examples of the trigger motion. As illustrated in FIG. 4, when the pointer 31 moves to a right periphery 32a of the screen on the display 15, the motion sensor 42 counts the number of times the pointer 31 touches the right periphery 32a. If the pointer 31 once returns to the left from the periphery 32a and then touches the periphery 32a again, the motion sensor 42 determines that the pointer 31 moves to the right periphery 32a twice. After the pointer 31 moves left and right repeatedly around the periphery 32a, if the pointer 31 touches the periphery 32a a predetermined number of times (e.g., three times), the motion sensor 42 detects a trigger motion with respect to the right periphery 32a of the screen.

Preferably, the motion sensor 42 counts the movements of the pointer 31 within a predetermined time period (e.g., five seconds) from when detecting a movement. The number of movements to be counted may be once. More specifically, if the pointer 31 touches the periphery 32a, the motion sensor 42 may detect a trigger motion with respect to the right periphery 32a.

Similarly, as illustrated in FIG. 5, when the pointer 31 moves to a left periphery 32b of the screen on the display 15, if the pointer 31 touches the periphery 32b a predetermined number of times, the motion sensor 42 detects a trigger motion with respect to the left periphery 32b of the screen.

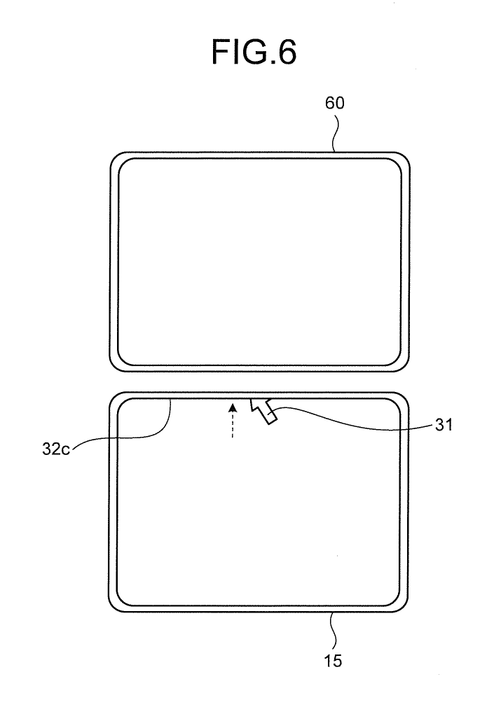

In addition, as illustrated in FIG. 6, when the pointer 31 moves to an upper periphery 32c of the screen on the display 15, if the pointer 31 touches the periphery 32c a predetermined number of times, the motion sensor 42 detects a trigger motion with respect to the upper periphery 32c of the screen.

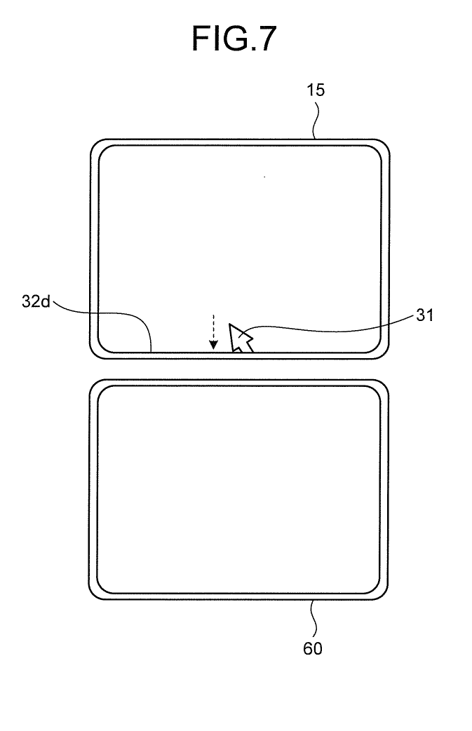

Further, as illustrated in FIG. 7, when the pointer 31 moves to a lower periphery 32d of the screen on the display 15, if the pointer 31 touches the periphery 32d a predetermined number of times, the motion sensor 42 detects a trigger motion with respect to the lower periphery 32d of the screen.

In this manner, if the pointer 31 moves to the same periphery 32a, 32b, 32c, or 32d (hereinafter referred to as “periphery 32” if it does not need to be on a particular side) a predetermined number of times, the motion sensor 42 detects a trigger motion with respect to the periphery 32.

When the motion sensor 42 detects a trigger motion, the display control module 41 sets the display position of the display 60 in the virtual display to a position corresponding to the periphery 32 (32a, 32b, 32c, or 32d) to which the pointer 31 moves.

More specifically, if the motion sensor 42 detects a trigger motion with respect to the right periphery 32a of the screen as illustrated in FIG. 4, the display control module 41 sets the display position of the display 60 to the right side of the display position of the display 15.

If the motion sensor 42 detects a trigger motion with respect to the left periphery 32b of the screen as illustrated in FIG. 5, the display control module 41 sets the display position of the display 60 to the left side of the display position of the display 15.

If the motion sensor 42 detects a trigger motion with respect to the upper periphery 32c of the screen as illustrated in FIG. 6, the display control module 41 sets the display position of the display 60 to above the display position of the display 15.

If the motion sensor 42 detects a trigger motion with respect to the lower periphery 32d of the screen as illustrated in FIG. 7, the display control module 41 sets the display position of the display 60 to below the display position of the display 15.

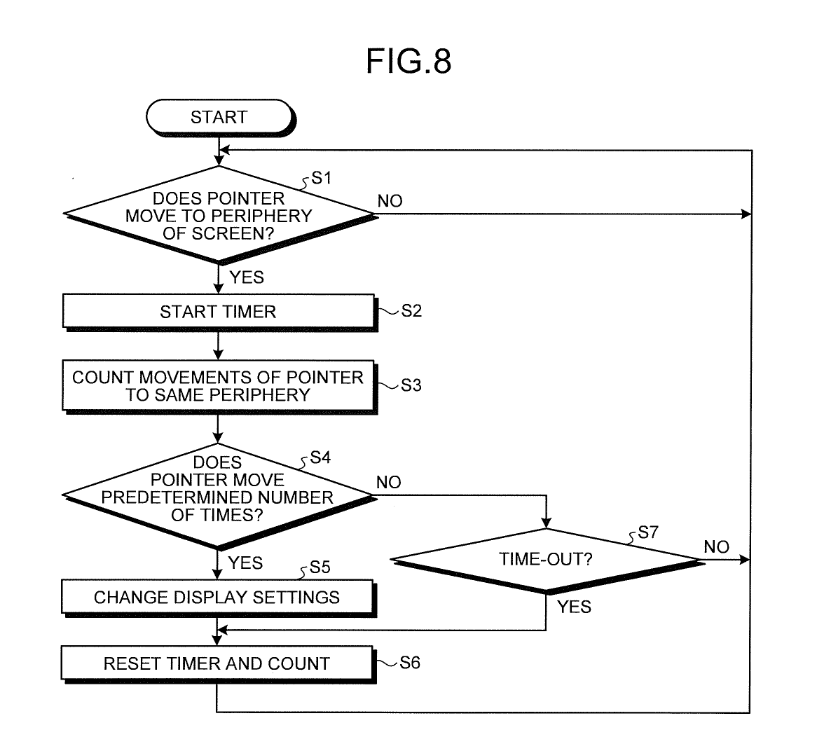

A description will be given of a display setting change process performed by the information processor 1. FIG. 8 is a flowchart of the display setting change process performed by the information processor 1.

First, the motion sensor 42 determines whether the pointer 31 moves to the periphery 32 (S1). If not (No at S1), the process returns to S1. If the pointer 31 moves to the periphery 32 (Yes at S1), the motion sensor 42 turns on a timer (S2), and counts the number of times the pointer 31 moves to the same periphery 32 (S3).

Thereafter, the motion sensor 42 determines whether the pointer 31 has moved to the same periphery 32 a predetermined number of times (S4). If the pointer 31 has moved to the same periphery 32 a predetermined number of times (Yes at S4), the motion sensor 42 determines that a trigger motion is detected with respect to the periphery 32. Then, the display control module 41 changes display settings so that the display position of the display 60 in the virtual display is set to a position corresponding to the periphery 32 (S5). The motion sensor 42 resets the timer as well as resetting the count of the number of movements (S6), and the process returns to S1.

If the number of movements of the pointer does not reach the predetermined number of times (No at S4), the motion sensor 42 determines whether the timer reaches time-out (S7). If the timer reaches time-out (Yes at S7), the process moves to S6. On the other hand, if it is not yet time-out (No at S7), the process returns to S1.

As described above, according to the first embodiment, if the pointer 31 moves to the periphery 32 a predetermined number of times, the display position of the display 60 is set to a position corresponding to the periphery 32. With this, screen display settings can be changed according to the movement of the pointer 31 without opening the settings screen for, for example, screen properties. Thus, it is possible to easily configure multi-display settings.

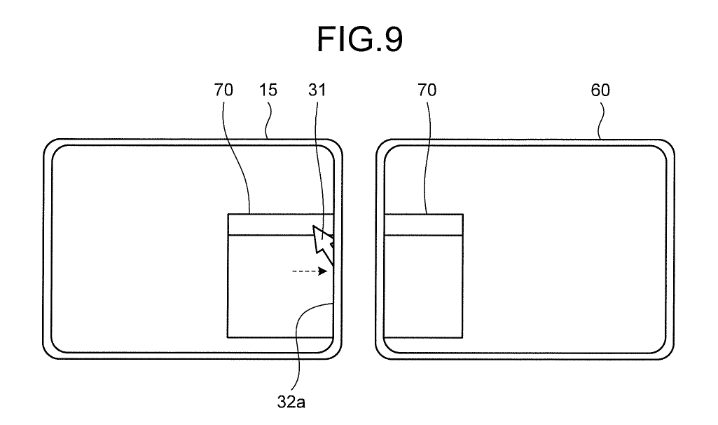

The trigger motion detected by the motion sensor 42 is not limited as described above. FIG. 9 is a schematic diagram for explaining a trigger motion in the case where a window 70 is dragged as an operation object. As illustrated in FIG. 9, if a predetermined display area such as the window 70 or an icon is dragged with the pointer 31, the motion sensor 42 may detect a trigger motion based on the number of movements of the pointer 31 in a similar manner to the above. In this case, the motion sensor 42 may count the number of times predetermined part of the window 70 moves to the periphery 32.

The foregoing can be applied to the case where there is a plurality of sub-displays. In a second embodiment, an example will be described in which display settings are configured for a plurality of sub-displays.

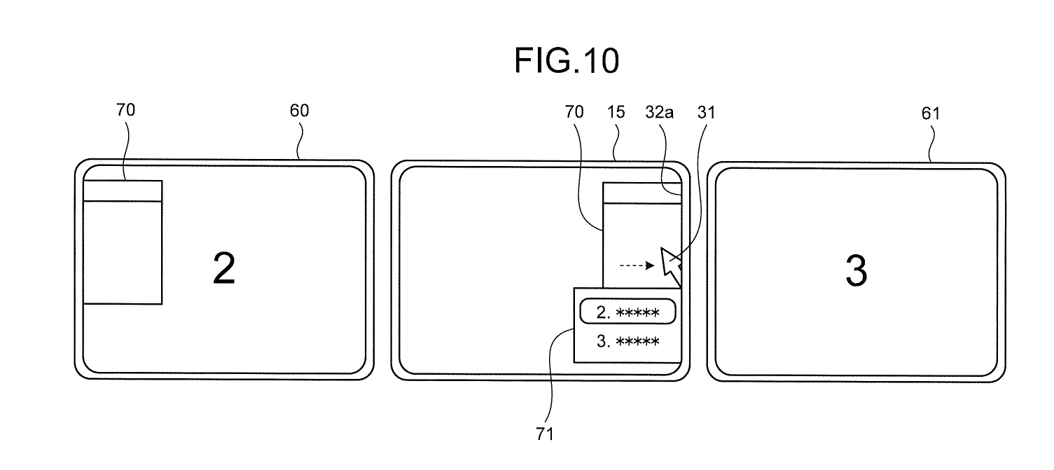

FIG. 10 is a schematic diagram for explaining display setting change operation according to the second embodiment. As illustrated in FIG. 10, the information processor 1 uses a plurality of sub-displays, i.e., a display 61 in addition to the display 60. The motion sensor 42 detects a trigger motion as in the first embodiment. For example, if the pointer 31 moves to the right periphery 32a of the screen a predetermined number of times, the motion sensor 42 detects a trigger motion with respect to the periphery 32a.

If the motion sensor 42 detects a trigger motion with respect to the right periphery 32a of the screen, the display control module 41 displays a dialog box 71 for selecting which of the displays 60 and 61 is to be set on the right side of the display 15. The dialog box 71 displays information such as display numbers, display names, and the like to select a display to be set on the right side of the display 15. The display control module 41 sets the display position of a display selected in the dialog box 71 to the right side of the display 15.

If the other display 61 is set on the right side of the display 15, the display control module 41 changes the display position of the display 61 to the left side of the display 15 to switch the display positions of the displays 60 and 61 between the right and left sides of the display 15 in the virtual display.

The display control module 41 may set the display position of the display 61 to other positions opposite the display 60 across the display 15. The display control module 41 may change the display position of the display 61 to other positions in the virtual display.

With this, as illustrated in FIG. 10, even if a change in the relative positions of the display 15 and the displays 60 and 61 changes the correspondence relationship of their display positions and, for example, the window 70 is not displayed appropriately, the display positions of the displays 60 and 61 can be easily switched.

Besides, as illustrated in FIG. 10, if the motion sensor 42 detects a trigger motion, the display control module 41 may display the display number on at least one of the displays 60 and 61. This facilitates to check the display number and to set the display position.

As described above, according to the first and second embodiments, when an operation object moves to the periphery of the screen a predetermined number of times, the display position of a display other than the main display is set to a position corresponding to the periphery where the movement of the operation object is detected. With this, screen display settings can be changed according to the motion of the operation object. Thus, it is possible to easily configure multi-display settings.

While an example is described above in which the motion sensor 42 detects a trigger motion on the display 15, the motion sensor 42 may, of course, detect a trigger motion on a sub-display such as the display 60 or 61.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a display controller configured to virtually arrange screens of a plurality of display devices to form a continuous screen for display; and
a detector configured to detect whether an operation object moves to a periphery of a main screen of the screens a predetermined number of times, wherein the display controller is configured to set display position of one of the screens other than the main screen to a position corresponding to the periphery where movement of the operation object is detected by the detector.

2. The information processor of claim 1, wherein the detector is configured to detect whether a pointer as the operation object moves to the periphery of the main screen the predetermined number of times.

3. The information processor of claim 1, wherein the detector is configured to detect whether a predetermined display area as the operation object is dragged and part of the display area moves to the periphery the predetermined number of times.

4. The information processor of claim 1, wherein the display controller is configured to virtually arrange a plurality of sub-screens with respect to the main screen in the continuous screen, the information processor further comprising:
a selector configured to select one of the sub-screens to be set to the position corresponding to the periphery where the movement is detected by the detector.

5. The information processor of claim 4, wherein, if the detector detects the movement, the display controller displays, on at least one of the sub-screens, information that identifies the screen.

6. The information processor of claim 4, wherein the display controller is configured to virtually arrange the sub-screens at opposite positions across the main screen in the continuous screen.

7. The information processor of claim 1, further comprising a display device configured to display the main screen.

8. An information processing method applied to an information processor, the information processing method comprising:
virtually arranging screens of a plurality of display devices to form a continuous screen for display;
detecting whether an operation object moves to a periphery of a main screen of the screens a predetermined number of times; and
setting display position of one of the screens other than the main screen to a position corresponding to the periphery where movement of the operation object is detected by the detector.

9. A computer program product embodied on a non-transitory computer-readable storage medium and comprising code that, when executed, causes a computer to:
virtually arrange screens of a plurality of display devices to form a continuous screen for display;
detect whether an operation object moves to a periphery of a main screen of the screens a predetermined number of times; and
set display position of one of the screens other than the main screen to a position corresponding to the periphery where movement of the operation object is detected by the detector.
